(19) United States
(12) Patent Application Publication
(10) Pub. No.: US 2022/0414522 A1
(43) Pub. Date: Dec. 29, 2022

(54) MACHINE LEARNING BASED RANKING OF HYDROCARBON PROSPECTS FOR FIELD EXPLORATION

(71) Applicant: Landmark Graphics Corporation, Houston, TX (US)

(72) Inventors: Samiran Roy, Bengaluru (IN); Soumi Chaki, Kolkata (IN)

(21) Appl. No.: 17/304,970

(22) Filed: Jun. 29, 2021

(51) Int. Cl. G06N 20/00; G01V 1/30

(52) U.S. Cl. CPC G06N 20/00; G01V 1/307; G01V 2210/63; G01V 2210/65

(57) ABSTRACT

An ensemble of machine learning models is trained to evaluate seismic and risk-related data in order to evaluate, value, or otherwise rank various prospective hydrocarbon reservoir (“prospects”) of a field. A classification machine learning model is trained to classify a prospect or region of a prospect based on the exploration risk level. From the seismic data, a frequency-filtered volume (FFV) for each prospect is calculated, where the FFV is a measure of reservoir volume which takes into account seismic resolution limits. Based on the risk classification and FFV, prospects of the field are ranked based on their economic value which is a combination of the risk associated with drilling and their potential reservoir volume.

### TECHNICAL FIELD

The disclosure generally relates to the field of earth or rock drilling and mining and to obtaining oil, gas, water, soluble or meltable materials or a slurry of minerals from wells.

### BACKGROUND

Valuing and drilling for hydrocarbon reservoirs in untapped basins or fields requires locating prospective hydrocarbon reservoirs (i.e., prospects) and geologically and economically evaluating such prospects. Before wells are drilled (or with otherwise limited drilling information), prospects are identified based on geological, seismic, and other non-invasive data acquired in the field. In order to price drilling contracts (or licenses) and determine economic viability of prospects for business decisions, prospect characteristics can be compared to those of similar geological features previously drilled and seismic data manually evaluated and scored based on direct hydrocarbon indications (DHI) and other geological features in order to determine reservoir potentials of such prospects.

### BRIEF DESCRIPTION OF THE DRAWINGS

Embodiments of the disclosure may be better understood by referencing the accompanying drawings.

FIG. 1 illustrates an example system for a risk classification stage of machine learning based prospect ranking for field exploration.

FIG. 2 illustrates an example system for a prospect ranking stage of machine learning based prospect ranking for field exploration.

FIG. 3 is a flowchart of example operations for ranking hydrocarbon prospects for field exploration with an ensemble of trained machine learning models.

FIG. 4 is a flowchart of example operations for calculating frequency filtered volume.

FIG. 5 is a flowchart of example operation for training a machine learning model to classify risk level for multiple prospects of a field.

FIG. 6 is a flowchart of example operation for training a machine learning model to rank prospects of a field based on at least risk level classification and frequency filtered volume.

FIG. 7 depicts an example computer system with a prospect risk level classifier and a prospect ranker.

### DESCRIPTION OF EMBODIMENTS

The description that follows includes example systems, methods, techniques, and program flows that embody embodiments of the disclosure. However, it is understood that this disclosure may be practiced without these specific details. For instance, this disclosure refers to seismic surveying in illustrative examples. Embodiments of this disclosure can be instead applied to magnetic surveying, gravitational surveying, etc. In other instances, well-known instruction instances, protocols, structures and techniques have not been shown in detail in order not to obfuscate the description.

### Overview

Prospective hydrocarbon reservoirs (i.e., prospects or leads) are identified in a geological field (which may be a basin or other lithological unit) based on seismic surveys, including acoustic information, or other spectroscopy and exploration methods (such as gravitational, magnetic, etc.). Traditional prospect identification and location is based on manual interpretation of seismic measurements of lithology. Manual interpretation for prospects of a large field requires significant manpower and identified prospects can be qualitatively or quantitatively misidentified due to measurement uncertainty, non-uniformities, manual interpretation discrepancies, etc.

An ensemble of machine learning models is trained to classify and rank prospects based on economic value. A first machine learning (ML) model classifies prospects according to a risk level classification. Prospects are then identified by a frequency filtered volume, which is a measure of reservoir volume. The frequency filtered volume is calculated based on a gross rock volume and a seismic resolution scale, for each prospect. A second ML model then ranks prospects, based on their identified risk level and frequency filtered volume, in order of economic value.

### Example Illustrations

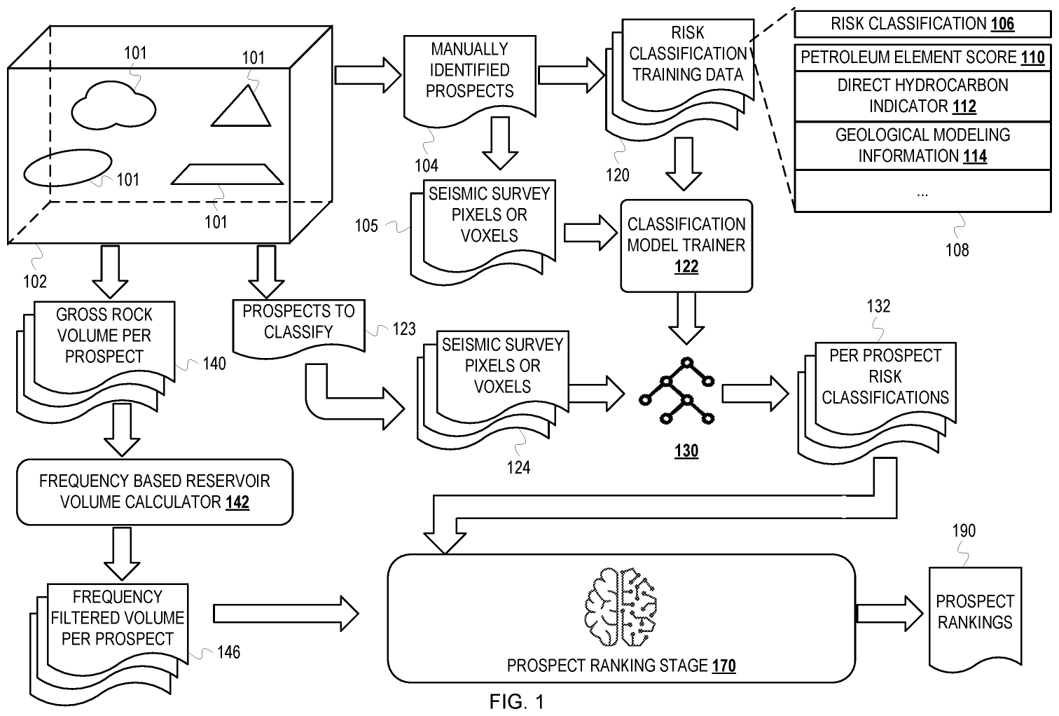

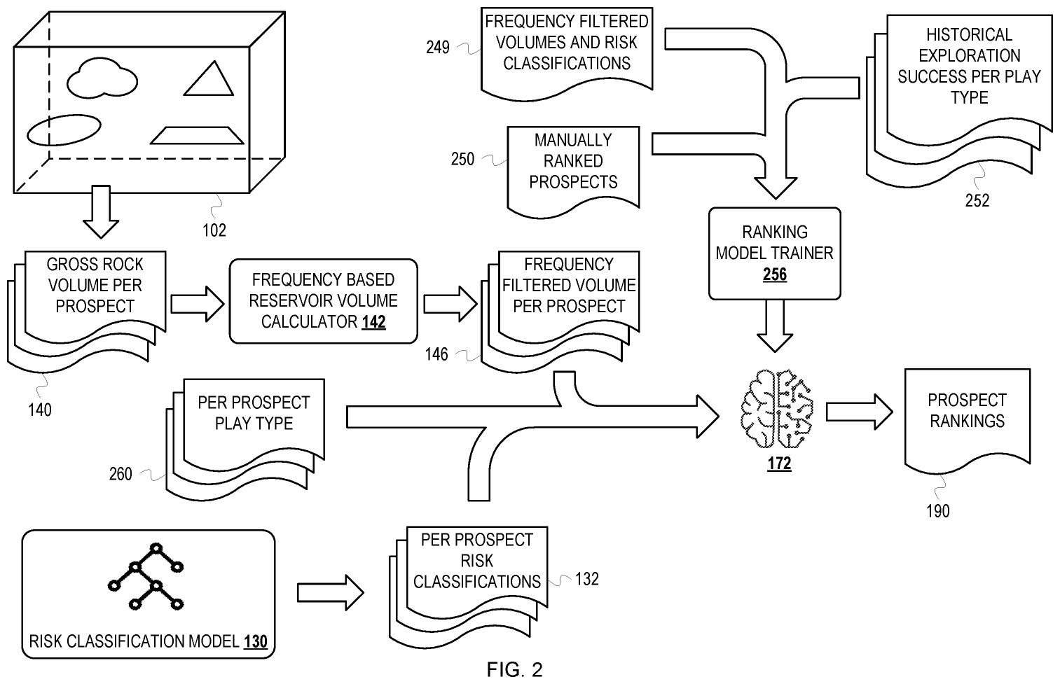

FIGS. 1-2 illustrate an example ensemble of machine learning models for risk classification of prospects and ranking of the prospects based partly on the risk classifications. FIG. 1 illustrates an example system for a risk classification stage of machine learning based prospect ranking for field exploration. Prospects 101 of a field 102, which can be a basin or other geographic or geological unit or group of units, are surveyed using seismic or other geological prospecting techniques. Manually identified prospects 104 are the basis for training and validation data to generate a trained risk classification model 130. The manually identified prospects 104 are manually identified based on seismological or other survey data. The manually identified prospects 104 are identified by interpreters (human or computer-based) based on structural or stratigraphical information contained within survey data. The manually identified prospects 104 may represent or contain the most obvious or largest of the prospects 101 of the field 102 or those for which the best quality survey data is available. The manually identified prospects 104 may represent or contain prospects corresponding to a variety of play types as represented in the prospects 101 of the field 102. Play type encompasses a geological classification of each of the prospects 101, where the geological classifications can include information about the source, geological history, lithology, etc. for each of the prospects 101 and prospects of similar play type may produce similar yield. Multiple of the prospects 101 can have the same or similar play types, and a play type can be found in multiple fields, including in fields across the world such as similar offshore oil plays which occur in both the Gulf of Mexico and Scandinavia.

A set of risk classification training data 120 is produced based on the manually identified prospects 104, where a part of the risk classification training data is used as validation or testing data. The risk classification training data 120 for the manually identified prospects 104 includes a risk classification 106 for each prospect based on one or more measure of estimated hydrocarbon presence, which can be a petroleum element score 110, a direct hydrocarbon indicator 112, an indicator from a geological model 114, etc. for each of the manually identified prospects 104—hereinafter referred to as reservoir risk factors 108. The petroleum element score 110 includes one or more of a source score, migration or migration path score, trap or trapment score, reservoir score, and seal or seal capacity score. The petroleum element score 110 can further include one or more of overburden score, maturation or maturity score, accumulation score, etc. The petroleum element score 110 for each prospect of the manually identified prospects 104 can be generated by human or computer interpretation. Elements of the petroleum element score 110 can be identified in seismological survey, or other lithological survey or map, where geological layers and characteristics correspond to various reservoir properties, such as source, migration path, trap or seal, reservoir volume, etc. The petroleum element score 110 can be a vector, such as an n-dimensional vector comprising each of the n values of the petroleum element score 110. The petroleum element score 110 can also be single value for each prospect of the manually identified prospects 104, where the value of the petroleum element score 110 is calculated based on the n values of the individual elements of the petroleum element score 110. Some prospects of the manually identified prospects 104 may have one or more element of the petroleum element score 110 equal to zero or a null value.

The direct hydrocarbon indicators (DHI) 112 are amplitude anomalies which occur in seismological survey data due to changes in pore fluids and bulk rock elastic property. DHI 112 can correspond to the presence of hydrocarbon reservoirs or other features which correspond to the presence of hydrocarbon reservoirs. DHI 112 can comprise bright spots, dim spots, flat spots, phase change, gas chimneys, shadow effects, cross-cutting reflectors, etc. in seismological survey amplitude. Each prospect of the manually identified prospects 104 is evaluated for presence or absence of one or more type of DHI 112 and optionally for strength or value of one or more type of DHI 112. Even large, well characterized reservoirs will not exhibit all types of DHI 112, so the absence of one or more DHI 112 does not preclude reservoir existence—and some DHI 112 are better indicators (i.e., may have a compounding effect) when observed together while other DHI 112 observed together may cancel each other out or indicate that no reservoir is present. Each prospect of the manually identified prospects 104 can correspond to a value for each of the DHI 112, including a n-dimensional vector comprising a value for each of the n DHI 112 evaluated, or a single value calculated based on the values of the n DHI 112.

Each prospect of the manually identified prospects 104 can also be manually evaluated to produce an indicator from other products or interpreters or geological models 114, which may include other predictions or identifications, such as play type, geochemical or lithological composition, rock properties, chronostratigraphology, etc. Indicators can be based on one or more geological or hydrocarbon reservoir model, such as those in the Neftex® Predictions framework and/or FairwayFinder software. Indicators can be one or more of a source presence, maturity and charge information, reservoir presence, seal presence, etc. and can be identified in one or more critical risk segment (CRS) map or can be consolidated into a common critical risk segment (CCRS) map. Each CRS can correspond to a mapped indicator: source, seal, reservoir, charge, etc. and be a map of locations where the indicator is found throughout the field. Composite CRS maps can also be generated for multiple indicators, such as source and charge, and trap and seal. The CCRS can correspond to conditions favorable for hydrocarbon reservoir formation, which can be areas where one or more of the other CRS overlap, within the field. CRS and CCRS maps can contain risk level information, where a given indicator is identified with variable levels of certainty over different areas of the map. For instance, reservoir map can identify areas where reservoir presence is determined with high probability (i.e., low risk), medium probability (i.e., medium risk), and low probability (i.e., high risk), where risk level for exploration is inversely proportional to reservoir detection certainty.

The reservoir risk factors 108 can also include other appropriate characteristic or score of the manually identified prospects 104. These may be additionally manually evaluated risk levels, play types, etc., including other input from geological models or databases.

A risk classification 106 value is generated for each of the prospects 101 of the manually identified prospects 104, based on the reservoir risk factors 108. Optionally, a risk classification 106 value is generated for each of the manually identified prospects 104 used as training data, but not generated or not used for those of the manually identified prospects 104 used as testing or validation data. The risk classification value 106 for each prospect is determined based on the totality of the petroleum element score 110, the DHI 112, the geological modeling information 114, and any other data included in the reservoir risk factors 108. The risk classification value 106 is a measure of likelihood that an economically viable hydrocarbon reservoir is found or exists at the location of each prospect. The risk classification value 106 can be a one of a range of values—i.e., a number 1 to 10, a risk level (e.g., low risk, medium risk, high risk), etc. Various indicators can have different weight when determining the risk classification value 106 for each prospect. For example, clear and strong DHI 112 can correspond to a low-risk risk classification value 106, even if a CCRS map does not indicate all CRS elements are favorable for hydrocarbon reservoir formation. As CCRS maps are based on geological knowledge (which may be fallible), an undetected trap or seal layer can cause the CCRS map to indicate that reservoir conditions are unfavorable but a seismic indication that hydrocarbons are present can be controlling on a risk level classification 106. The risk classification value 106 for each prospect can be assigned manually or computationally based on the values of the reservoir risk factors 108.

A classification model trainer 122 then trains a classifier (e.g., an artificial neural network) to generate the trained risk classification model 130 to classify the remaining prospects 101 of the field 102 by risk. The classifier can be any tree-based algorithm, such as a random forest, artificial neural network, etc. The classification model trainer 122 trains a classifier with the risk classification training data 120 to generate a per prospect risk classification based on seismic survey data 105 or feature values associated with the seismic survey data 105 corresponding to the manually identified prospects 104. The input vectors can also include the values of one or more of the reservoir risk factors 108 or feature values based on one or more of the reservoir risk factors 108.

The training termination criterion can be defined with a minimum confidence interval or probability. However, training iterations may be bounded by the size of the manually identified prospects because manually identifying prospects can be time consuming and costly. Due to the likelihood of a small set of training data, the resources expended curating the training data likely ensure inclusion of high-quality prospects (i.e., those with strong DHI 112 or the like) with respect to training the classifier.

The seismic survey data 105, 124 input for risk classification may be pixels, for a two-dimensional (2D) survey, or voxels, for a three or four-dimensional (3D or 4D) survey. The risk classification model 130 generates a risk classification for each region of the survey, where a region may be as small as a pixel or voxel of the survey data and as large as the prospect 101 of the field 102. The risk classification model 130 can be designed with an architecture to determine risk classification based on a region smaller than a prospect (e.g., pixel, voxel, region of a prospect, unit area, unit volume, etc.) and then integrate, average, or determine an overall risk classification over one or more regions to create a per prospect or per unit area or per unit volume risk classification. The per prospect risk classifications 132 are then fed to a prospect ranking model in a prospect ranking stage 170, which is further illustrated in FIG. 2.

The prospect ranking stage 170 includes the prospect ranking model, and determines prospect rankings 190 for the prospects 101 of the field 102 based on the per prospect risk classifications 132 and a frequency filtered volume 146 per prospect.

A frequency-based reservoir volume calculator 142 generates the frequency filtered volumes (FFVs) 146 from gross rock volumes 140. For each prospect 101 of the field 102 the gross rock volume 140 is calculated. The gross rock volume (GRV) 140 is a measure of the volume of rock which constitutes the potential reservoir of the prospect. Total hydrocarbon volume of the potential reservoir is limited by the GRV 140 and the porosity (and other petrochemical factors) of the rock which makes up the reservoir volume. GRV 140 is a measure of the volume located between the top or cap rock and the bottom or based rock of the potential reservoir. GRV 140 is calculated based on seismological or other survey data of the field 102 for each prospect 101 or for an area or volume of the field 102. The calculation of GRV 140 is affected by the survey resolution—that is GRV 140 is calculated based on the measured distance or volume between a cap and base of a reservoir and can be overestimated based on resolution induced errors in the measured locations of geological layers comprising either cap or base.

The frequency-based reservoir volume calculator 142 determines the resolution of the seismological or other survey at the cap and base of the potential reservoir of each prospect 101 of the field 102, or for each pixel or voxel of the survey data. Seismological survey data is measured in length and width (i.e., in distance or distance squared) as a function of surface area, but depth is measured as a function of time, frequency, or wave velocity for the interrogating sound waves. The depth resolution (i.e., resolution distance in the z-direction) therefore depends on the frequency of the waves which reach or interrogate rock layers at a given depth. In some cases, resolution decreases as a function of depth in the formation where higher frequency sound waves travel less efficiently through rock and dissipate before reaching greater depths. For instance, in an example seismological survey shallow lithology was interrogated with a dominant frequency of 50 hertz (Hz) while deeper lithology displays a dominant frequency of 20 Hz. In such a case, the shallow formations exhibit a resolution of 10 meters (m) while the deeper formations exhibit a resolution of 20 m. Exact dominant frequencies and resolution scales can vary, including instances where dominant frequencies are altered by subsurface formations and are not solely a function of depth but also of position in the surface or x-and-y plane.

The frequency-based reservoir volume calculator 142 determines a dominant frequency for the seismic (or other) survey data at each prospect 101 of the field 102 or region of the measured data. Based on the dominant frequency, a resolution scale is calculated for each prospect 101 or region. A prospect 101 can correspond to a potential reservoir with varying resolution scales, in which case the resolution scale is calculated for various regions of the prospect 101.

The frequency-based reservoir volume calculator 142 compares each measured thickness of the potential reservoir with the determined resolution scale. The measured thicknesses can be calculated per prospect, per voxel, per region or per unit of the reservoir. For measured thicknesses greater than the resolution scale, the measured thickness is accepted as the frequency-filtered thickness (or multiplied by a factor of 1 (i.e., unity)). For measured thicknesses smaller than the resolution scale, the measured thickness is multiplied by an estimated thickness scaler (e.g., scalar factor σ) of less than one.

The frequency-based reservoir volume calculator 142 then sums or integrates over the scaled volume of each prospect to determine the frequency filtered volume 146 per prospect. The frequency filtered volume 146 per prospect removes overestimation of reservoir volume at deeper depths or larger resolutions in the seismological or other survey present in the GRV 140, which enables better estimation of reservoir economic viability.

The prospect ranking stage 170 operates on the frequency filtered volume 146 per prospect together with the per prospect risk classification 132 to determine the prospect ranking 190. The prospect ranking 190 is a set of the prospects 101 of the field 102 ordered or ranked by their predicted economic value. The ranking can be a value, such as a number 1 to 100, or a probability, such as highest likelihood to lowest likelihood, or an ordered set of the prospects 101 where the ordering determines the ranking of each of the prospects 101. The prospects can be ranked such that prospects can have equal rankings (e.g., first prospect is prospect X, second prospect is prospect Y and prospect Z, third prospect is null, fourth prospect is prospect A, etc.) or such that each ranking is assigned only one prospect. The prospects can be assigned a value which corresponds to their ranking. For example, if there are 64 prospects of the field 102, prospect A's rank can be 1, prospect B's rank can be 2 . . . through prospect Z with a rank of 64.

FIG. 2 illustrates an example system for a prospect ranking stage of machine learning based prospect ranking for field exploration. FIG. 2 depicts a ranking model trainer 256, a prospect ranking model 172 generated from the ranking model trainer 256, training data, and input data.

The ranking model trainer 256 trains a ranking algorithm or learning to rank algorithm (e.g., regression model, artificial neural network, etc.) to generate the prospect ranking model 172 to rank prospects 101 of the field 102 based on FFVs and prospect risk classifications. Embodiments can also train a ranking model to rank prospects also based on play type. For training data, a subset of the prospects 101 of the field 102 are selected and manually ranked to yield manually ranked prospects 250. The manually ranked prospects 250 can include at least some of those prospects of the manually identified prospects 104 used in risk classification training.

The ranking model trainer 256 trains a model to indicate the rankings indicated manually for the manually ranked prospects 250 based on at least frequency filtered volumes (FFVs) and risk classifications 249 of the manually ranked prospects 250, the seismological or other survey data of the manually ranked prospects, and historical exploration success per play type 252 values. The historical exploration success per play type 252 can be an additional risk level classification (e.g., high risk, medium risk, low risk), can be a scaling factor which adjusts either input frequency filtered volume or per prospect risk classification of the FFVs and risk classifications 249, etc. The historical success per play type 252 encompasses differences in production for various play types, where some play types historically overproduce (due to underestimation of reservoir size, favorable surface tension factors, etc.) and some play types historically underproduce (due to low recovery factors, tightly bound hydrocarbons, etc.). The historical success per play type 252 can be updated or improved based on new drilling information—which can quantitative such as drilled reservoir volume or qualitative such as ease of drilling reservoir—for the play type drilled in the field 102, in another field or area of a basin, or a similar play type located elsewhere in the world.

The manual ranking of the manually ranked prospects 250 can be determined by an operator, program, or other seismological or survey interpreter based on historical knowledge of petrogeology, drilling difficulty, economic viability of various reservoir, etc. For instance, prospects with similar play types but at different depths can be ranked such that the shallower or easier to drill prospect is ranked ahead of a deeper or more difficult to drill play. The manual ranking of the manual ranked prospects 250 is a value for each prospect or an ordered set of prospects and corresponding values based on at least a measure of economic value. A factor in selection from the prospects 101 for manual ranking can be diversity of training data, for example, to include both large prospects and those with poor economic value. Since manually ranking prospects, like manual risk classification, can be both expensive and time consuming, training may terminate upon exhaustion of the manually ranked prospect instead of achieving a degree of confidence.

After training yields the prospect ranking model 172, data for each remaining prospect or selected ones of the remaining prospects (i.e., those not manually ranked) are fed into the prospect ranking model 172. For each of the to be ranked prospects, the frequency filtered volumes 146, the per prospect risk classifications 132, and, optionally, the per prospect play type 260 are input into the prospect ranking model 172. This data for n prospects can be organized into an n×m dimensional input vector with each prospect entry having a length of m corresponding to the vector elements for FFV, risk classification, and play type for each prospect. The prospect ranking model 172 generates a ranking of the n prospects that can then be modified or supplemented with the manually ranked prospects. In some cases, the input can also include the data for the manually ranked prospects 250 and allow evaluation of the output again.

The n×m dimensional input vector can be a matrix. Model input can be reconfigured based on the number of input vectors. In some embodiments, an n×m input vector can be used to rank k prospects where k<n, in which case k-n rows of the input vector can be equal to zero or null or otherwise padded to produce a n×m input vector. If the model is configured to accept an n×m input vector but there are p prospects to rank where p>n, then the model can be reconfigured to accept a p×m input vector or input vectors of p prospects.

The ensemble of the risk classification model 130 and the prospect ranking model 172 can be retrained or updated with ongoing training based on updated information. The components of the ensemble can be retrained or updated in tandem or individually. To illustrate, a play similar to at least one play of the prospects 101 of the field 102 may play out or be drilled in the field 102 or elsewhere in the world. Based on this information, the risk classification may change. The risk classification model 130 can be retrained accordingly. Subsequently, the prospect ranking model 172 can be updated based on updated historical exploration success per play type.

The following flowcharts depict example operations for prospect ranking, FFV value calculation, and training of the ensemble of models used in the prospect ranking. While the flowcharts refer to actors with naming consistent with the preceding Figures, naming and organization of program code can be dependent upon programming language, platform, development guidelines, and/or may be arbitrary (e.g., developer preferences). Thus, the scope of the claims is not constrained by any naming or organization of the example flowcharts.

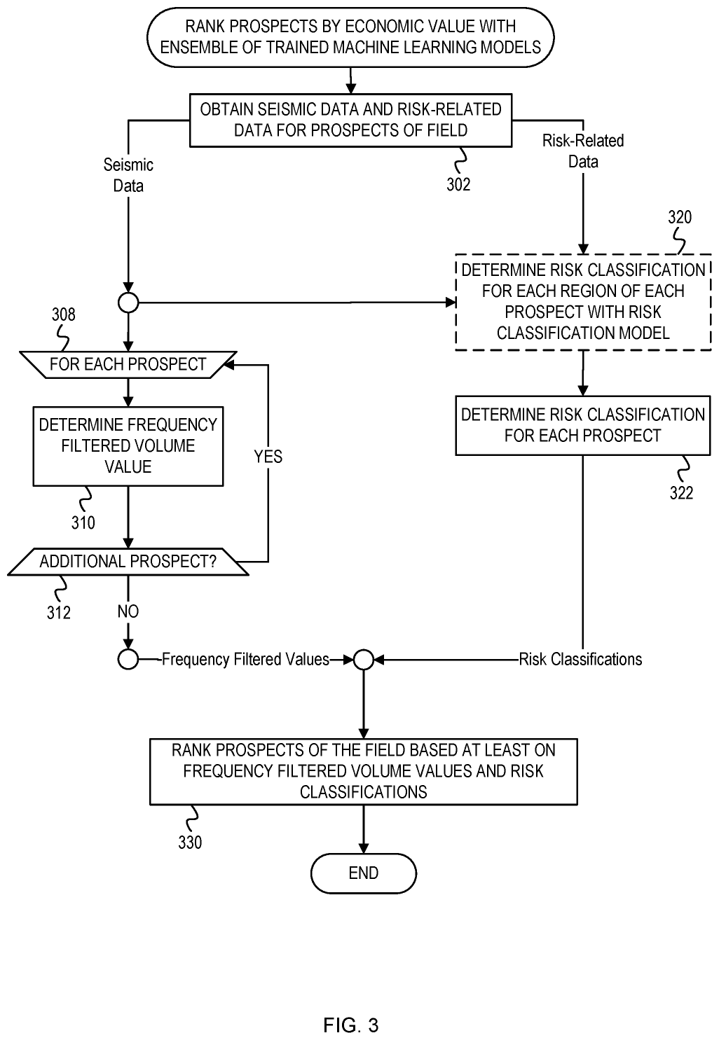

FIG. 3 is a flowchart of example operations for ranking hydrocarbon prospects for field exploration with an ensemble of trained machine learning models. The flowchart contains example operations described with reference to a trained risk classification model, a frequency-based reservoir volume calculator, and a prospect ranking model for consistency with earlier figures.

At block 302, an ensemble of trained machine learning models obtains seismic data and risk-related data for prospects of a field. The seismic data can be output from any appropriate seismic surveying operation or imported from a database of previously obtained seismic information. The seismic data can comprise 2D, 3D, 4D, etc. seismic data and can encompass all or parts of a field, basin, or other geologic unit. The risk-related data for the prospects of the field can comprise risk-related data obtained during or based on the seismic data, including risk-related data obtained through manual interpretation of seismic data. The risk-related data can include petroleum element score, DHI, geological modeling information (such as CCRS), and other reservoir risk factors.

At block 308, the frequency-filtered volume calculator begins iterating through indicated prospects to calculate FFV values for the prospects. In each iteration, the FFV calculator selects a prospect of the seismic data. The frequency-filtered volume calculator can select prospects based on location in the field, based on order in the seismic data, etc.

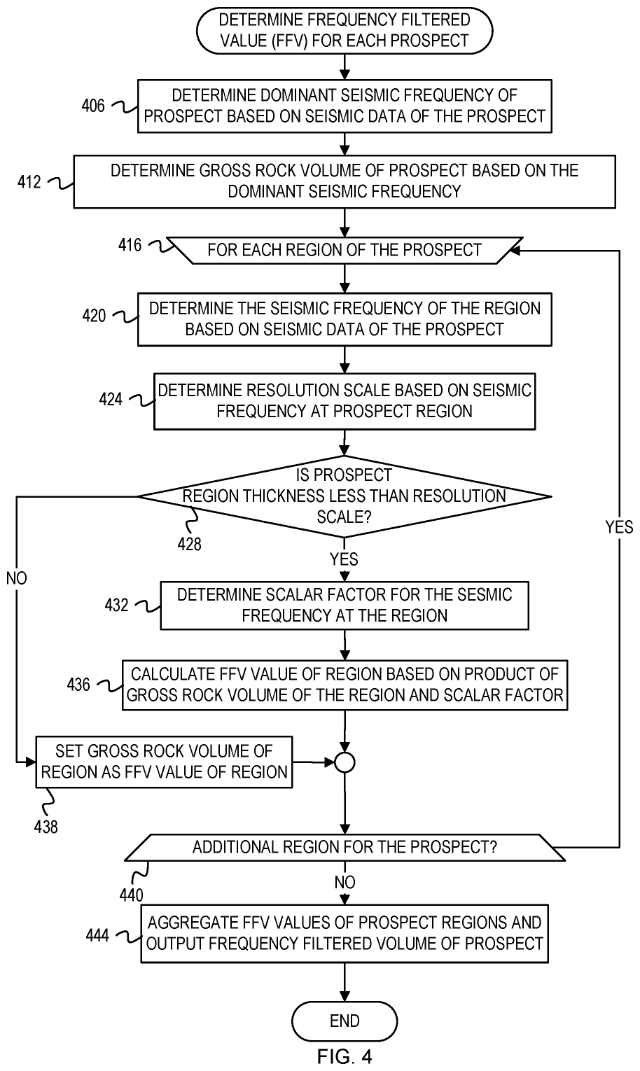

At block 310, the frequency-based reservoir volume calculator determines a frequency filtered volume value for each prospect based on the obtained seismic data. The frequency filtered volume (FFV) value can be a volume measurement, such as cubic meters (m³), barrels, etc., or can be in a seismic-survey-based volume such as square meters times frequency (m²*Hz), or other appropriate measurement. The frequency-based reservoir volume can be determined for each prospect or for each region of a prospect. If the FFV is determined for each region of the prospect, the prospect FFV can be calculated as a sum of the FFV of the regions of the prospect. FIG. 4 will elaborate on example operations for determining FFVs.

At block 312, the frequency-filtered volume calculator determines if an additional prospect of the field remains for evaluation. If there exits any additional prospect of the field for which a frequency filtered volume has not been calculated, flow continues to block 308 where another prospect is selected for evaluation.

At block 320, the ensemble of trained machine learning models determines a risk classification for each region of each prospect with the risk classification model. The region size and determination can be configurable or depend on seismic data (e.g., seismic resolution scale, seismic frequency at the prospect, etc.). The trained risk classification model determines the risk classification for each region based on the obtained seismic data and risk-related data. In some cases, the risk-related data may not be available for all regions or all prospects of the field.

At block 322, the ensemble of trained machine learning models determines a risk classification for each prospect. Embodiments may not consider sub-units of a prospect (i.e., regions), in which case block 320 would not be performed. If there are no sub-units to consider, the seismic data and risk-related data of each prospect is used to classify risk of each prospect with the risk classification model. If prospect sub-units are considered and a prospect contains multiple regions, then the risk classifications of the prospect determined at block 320 would be determined based on the risk classifications for the for the regions output by the risk classification model. For example, the risk classification for a prospect can be selected from the risk classifications of the regions of the prospect output by the risk classification model based on a defined criterion or rule (e.g., the lowest risk classification, the risk classification of the largest region, etc.). Embodiments may aggregate the risk classifications of the regions of the prospect to determine the risk classification of the prospect (e.g., the risk classifications can be averaged, integrated, or summed).

At block 330, the ensemble of trained machine learning models ranks prospects of the field based at least on frequency filtered volume values and risk classifications. The ranking may be a value or may be an ordered set of prospects. The ranking can operate on the prospects of a field together, including optionally those prospects of the training data, or can operate on the prospects sequentially where prospects of the field can be ranked in order once each prospect has an associated ranking value.

FIG. 4 is a flowchart of example operations for calculating frequency filtered volume. The flowchart contains example operations described with a frequency-based reservoir volume calculator for consistency with earlier figures. The frequency-filtered volume calculator can be part of a gross rock volume calculator or seismic data collector or evaluator.

At block 406, the frequency-filtered volume calculator determines the dominant seismic frequency of the prospect based on seismic data of the prospect. The dominant seismic frequency of the prospect can be the dominant frequency of the seismic survey which contains the prospect. The dominant seismic frequency can depend on the location of the prospect within the field, the frequency of the seismic source, and the frequency detection limits of the seismic receiver. The dominant seismic frequency of the prospect can vary between seismic surveys if the prospect is interrogated in multiple seismic surveys. The dominant seismic frequency is determined based on the seismic survey selected and not applicable to multiple surveys.

At block 412, the frequency-filtered volume calculator determines a gross rock volume (GRV) of the prospect based on the dominant seismic frequency. To determine the GRV, the FFV calculator can calculate the GRV or obtain the GRV value from a gross rock volume calculator or other processor or calculator unit. The gross rock volume is determined based on a seismic survey and the dominant seismic frequency of that survey. In some cases, a GRV can be calculated based on multiple seismic surveys (such as perpendicular 2D seismic surveys), where each seismic survey exhibits a dominant seismic frequency from which a gross rock volume (or gross rock area) is calculated and where the gross rock volume of multiple surveys can be integrated, multiplied, average, etc. to calculate a single gross rock volume for a prospect.

At block 416, the frequency-filtered volume calculator begins to iterate through regions of the currently selected prospect. Large prospects or prospects with multiple seismic frequencies (such as those at a depth at which the seismic frequency of interrogation changes) are divided into regions based on seismic frequency. Regions can be of a predetermined size—such as a number of pixels or voxels—or can be selected based on seismic frequency detected or measured at the region. Regions can be determined in the volume space or in the frequency space (i.e., where seismic data is accumulated in the m²*Hz space). Seismic data is collected in a frequency space, where sound wave velocity and frequency are measured instead of depth, and then converted to volume (or volume space) in order to calculate GRV. The frequency-filtered volume calculator can operate in the frequency space on as-collected data, or in the volume space on data previously converted to volume measurements (such as GRV) as long as a value corresponding to the frequency or resolution of the collected data is obtained or retained. In some cases, the prospect has a single region (e.g., the region is the prospect, or the region is as large as the prospect).

At block 420, the frequency-filtered volume calculator determines the seismic frequency of the region based on the seismic data of the prospect. The seismic frequency of the region corresponds to the seismic waves which interrogate the region. The seismic frequency is measured at one or more detector as a function of the seismic waves which are detected or measured. The relationship between the dominant wavelength, dominant frequency, and velocity of seismic waves is given by Equation 1, below:

$$λ = \frac{v}{f} \qquad ( 1 )$$

where λ is the dominant wavelength, v is the velocity, and f is the dominant frequency of the detected seismic wave. The dominant frequency can therefore be determined from the seismic wave velocity or the seismic wave arrival time and the dominant wavelength or directly measured.

At block 424, the frequency-filtered volume calculator determines the resolution scale based on the seismic frequency at the prospect region. The resolution scale is a function of seismic wavelength, which is related to seismic frequency as shown in Eq. 1 above. The resolution scale is the limit of resolution for which features smaller than the resolution scale cannot be measured accurately or the limit of separation at which features closer than the resolution scale appear to be a single feature. For example, if two layers of a reservoir are closer together in distance than the resolution scale, they can appear as a single layer in a seismic survey. Features and distances larger than the resolution scale can be viewed distinctly in the seismic survey.

At block 428, the frequency-filtered volume calculator determines if the prospect region thickness is less than the resolution scale. The prospect region thickness is the distance between the cap layer and base layer of the reservoir. The prospect region thickness is calculated from the seismic survey. The prospect region thickness can be calculated during the calculation of the GRV and stored for later use, or can be calculated or re-calculated based on the seismic survey of the region. If the prospect thickness is less than the resolution scale, flow continues to block 432. If the prospect thickness is greater than the resolution scale, flow continues to block 438.

At block 432, the frequency-filtered volume calculator determines a scalar factor for the seismic frequency at the region. The scalar factor is determined based on the seismic frequency at the region. The scalar factor can be calculated based on at least one of the resolution frequency, the dominant wavelength of the seismic data, and the dominant seismic frequency of the seismic data for the region. The scalar factor can be obtained from a database, loop up table, or other reference based on the seismic frequency of the seismic data for the region.

At block 436, frequency-filtered volume calculator calculates an FFV value of the region based on a product of the gross rock volume of the region and the scalar factor. The value of the FFV for the region is calculated using Equation 2, below, or similar:

FFV=σ*GRV (2)

where GRV is the gross rock volume of the region, a is the scalar factor, and FFV is the frequency-filtered volume of the region. In some instances, the scalar factor may also depend upon the GRV or on a relationship between the resolution scale and the prospect thickness of the region.

At block 438, the frequency-filtered volume calculator sets the gross rock volume as the FFV value of the region. Since the prospect region thickness was determined to be greater than the resolution scale (428), the GRV is used.

At block 440, the frequency-filtered volume calculator determines if another region exists for the prospect. If another region of the prospect remains to be evaluated, flow continues to block 416 where another region of the prospect is selected for evaluation. If no other regions of the prospect remain to be evaluated, flow continues to block 444.

At block 444, the frequency-filtered volume calculator aggregates the FFV values of the regions of the prospect and outputs the frequency filtered volume of the prospect. For example, the frequency-filtered volume calculator sums the FFV value of the regions of the prospect.

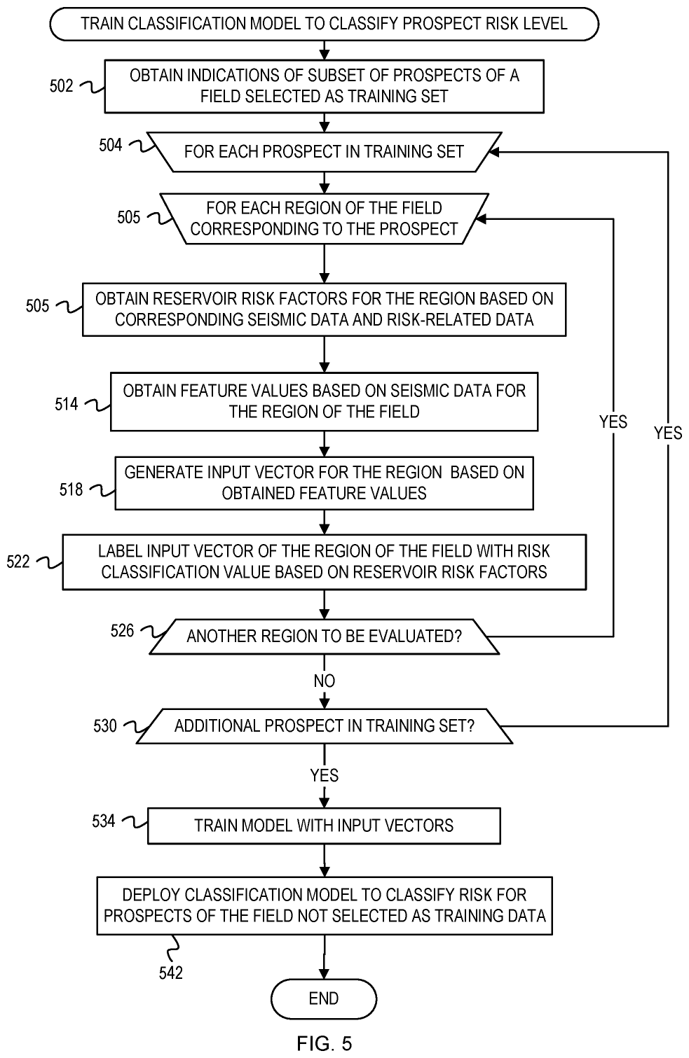

FIG. 5 is a flowchart of example operation for training a machine learning model to classify risk level for multiple prospects of a field. As discussed earlier, the resulting trained risk classification model is used to generate risk classifications for prospects, and the risk classifications are then used for prospect ranking.

At block 502, the risk classification model trainer obtains indications of a subset of prospects of a field selected as a training set. The indications include seismic data and risk-related data. The prospects selected as the training set can include the largest or most prominent prospects of the field, including those with visible DHI and other significant risk-related data which is easily obtainable or determinable from seismic data. The subset of prospects selected for the training set may be limited by the expense and time required to obtain manual interpretation data and the total number of prospects of the field. Therefore, the number of prospects included in the subset of prospects can be small or smaller than would otherwise be expected based on well-known training data selection methods.

At block 504, the classification model trainer begins iterating through the prospects selected for the training set. In each iteration, the classification model trainer selects a prospect by a prospect indication which is associated with the corresponding seismic data and risk-related data.

At block 505, the classification model trainer begins iterating through each region of the field corresponding to the currently selected prospect. A region corresponding to a prospect may be entirely within boundaries of the currently selected prospect or partially within the boundaries of the currently selected prospect. Region size can be dependent on the granularity of the obtained reservoir risk factors or resolution of the seismic data. Order of selection of regions for iterating can be based on location within the field, occurrence in data or data structure of the prospect, etc.

At block 506, the risk classification model trainer obtains reservoir risk factors for the region of the currently selected prospect. The reservoir risk factors are based on seismic data and risk-related data of the region. The reservoir risk factors can be obtained from geological models or outputs of geological models (such as CCRS maps), obtained from manual interpretation of seismic data (such as DHI and petroleum element scores), obtained from drilling, etc.

At block 514, the risk classification model trainer obtains feature values from the seismic data for the region. Features for risk classification will most likely be consistent across fields. Thus, the features will most likely be predefined. Features can be extracted from seismic data, from interpretation of the seismic data, trapping mechanism analysis from structural maps or isopach maps, etc. Examples of features for risk classification include seal thickness, reservoir facies thickness, root mean squared (RMS) amplitude values for reservoir intervals, etc. from seismic data, and average maturity score, maximum petroleum element score, play type, total organic carbon (TOC) CCRS-map-based features from geological and/or modeling data. In some embodiments, a risk classification feature set also includes DHI. The risk classification model trainer reads and/or derives values for the features that have been selected for the model from the data of the prospect region.

At block 518, the risk classification model trainer generates an input vector for the region based on the obtained feature values. The input vectors can be of variable length or contain null values if not all feature values are obtained for all regions of the field selected as training data. Obtained feature values and input vector length can vary based on size of region, available feature values, etc. The training populates the input vector with the obtained feature values according to the architecture of the model in training.

At block 522, the risk classification model trainer labels the input vector of the region of the field with a risk classification value based on the reservoir risk factors. The labeling can be based on a manual interpretation of the seismic data and risk-related data. The label can be a risk value (i.e., a numerical value) or a qualitative value (i.e., low risk, medium risk, etc.). The label can be based on the risk-related data, where such data is manually interpreted or automatically interpreted (such as in a CCRS map). The label can be applied based on a manual or expert geological evaluation of at least the seismic data.

At block 526, the risk classification model trainer determines if another region remains to be evaluated. If another region remains to be evaluated, flow continues to block 505 where another region is selected for evaluation. If no other regions remain to be evaluated, flow continues to block 530.

At block 530, the risk classification model trainer determines if there is an additional prospect in the train set. If there is an additional prospect in the training set, then flow returns to block 504. Otherwise, flow continues to block 534.

At block 534, the risk classification model trainer trains a classification model with the input vectors that have been generated. Internal model parameters are adjusted based on the evaluation of risk classifications against labels. Embodiments can feed the input vectors in at different times (e.g., as each is generated, after all regions of a prospect are evaluated, etc.).

For this example, it is assumed the training termination criterion is implied by the prospect training set. A given amount of resources (e.g., 20 person hours) is expended to curate the training set and training is complete once the trainer has iterated through the training set. However, a termination training criterion can be applied based on model performance, such as a generalization error criterion. If the performance-based criterion is not satisfied, embodiments can generate a notification or indication that an additional set of one or more prospects be added to the training set.

At block 542, the risk classification model trainer deploys the classification model to classify risk for prospects of the field not selected as training data. Optionally, the risk classification model trainer can deploy a model to classify risk for substantially all prospects of the field including those prospects included in the training data for which risk classifications have been previously generated.

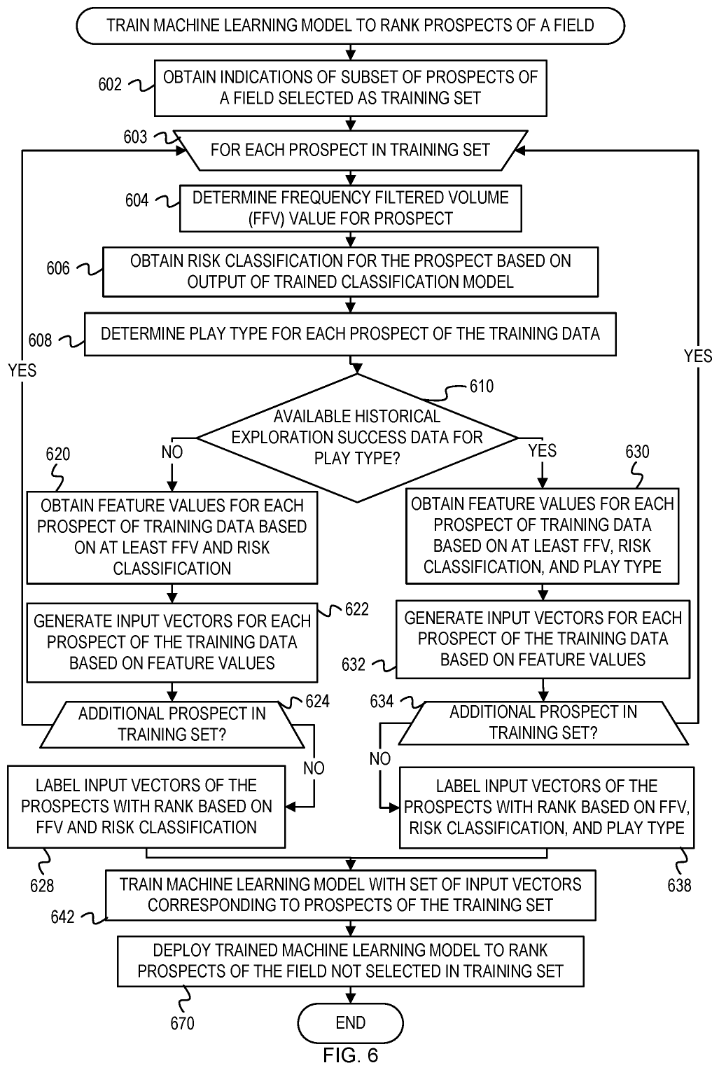

FIG. 6 is a flowchart of example operation for training a machine learning model to rank prospects of a field based on at least risk level classification and frequency filtered volume. As discussed earlier, the resulting trained ranking model is used to generate prospect ranking for prospects of a field.

At block 602, the prospect ranking model trainer obtains indications of a subset of prospects of a field selected as training set. The indications include seismic data and, optionally, risk-related data and play type related data. The prospects selected as the training set can include both high risk and low risk prospects of the field, where risk can be manually identified or identified using the trained risk classification model. The subset of prospects selected for the training set may be limited by the expense and time required to obtain manual interpretation data and the total number of prospects of the field. Therefore, the number of prospects included in the training data can smaller than would otherwise be expected based on well-known training data selection methods.

At block 603, the prospect ranking model trainer begins iterating through the prospects selected for the training set. In each iteration, the prospect ranking model trainer selects a prospect by prospect indication which is associated with the corresponding seismic data and risk-related data.

At block 604, the prospect ranking model trainer determines a frequency filtered volume (FFV) value for the currently selected prospect of the training data. The FFV value can be determined with any appropriate FFV calculator, such as the frequency-filtered volume calculator described in reference to FIG. 4. The FFV is determined based on seismic data. The FFV value can be calculated for the currently selected prospect based on seismic data or can be pre-calculated for prospects where the FFV value is then looked up or otherwise obtained from a look up table or database for the currently selected prospect.

At block 606, the prospect ranking model trainer obtains a risk classification for the currently selected prospect of the training data based on an output of a trained classification model. The risk classification can be determined with any appropriate risk classification model, such as the model trained by the risk classification model trainer described in reference to FIG. 5. The risk classification is determined based on risk-related data and, optionally, seismic data.

At block 608, the prospect ranking model trainer optionally determines play type for the currently selected prospect of the training data. The play type can be obtained from a geological model, manual interpretation, based on seismic data, etc. Play type can be broadly grouped, such as oil play versus gas play, or include more information or smaller granularity such as age or era, cap layer, base layer, grain size, depositional mechanism, etc. For some prospects and in some fields, play type may be unavailable or undetermined.

At block 610, the prospect ranking model trainer determines if there is available historical exploration success data for the determined play type. If historical success data for play type is not available—which can also occur if the play type is unknown or undetermined—flow continues to block 620. If historical success data for play type is available, flow continues to block 630. Historical exploration success data for play type can encompass an over production or under production factor, such as an adjustment to FFV value, or can be used to modify risk classification of a prospect based on play type.

At block 620, the prospect ranking model trainer obtains feature values for the currently selected prospect of the training data based on at least FFV and risk classification. Features for ranking will most likely be consistent across fields, therefore features will most likely be predefined. Examples of feature values include FFV and risk classification. In some embodiments, a ranking feature set can also include other variables such as depth in the reservoir, fracking requirements, pore pressure, etc. The prospect ranking model trainer reads and/or derives values for the features that have been selected for the model from the data of the selected prospect.

At block 622, the prospect ranking model trainer generates input vector for the currently selected prospect of the training data based on the feature values. The input vectors can contain null or empty values for one or more feature value of a prospect and the input vectors can be of variable length. Obtained feature values and input vector length can vary based on prospect size and available features.

At block 624, the prospect ranking model trainer determines if there is an additional prospect in the training set. If there is another prospect in the training set, flow continues to block 603 where another prospect is selected. Otherwise, flow continues to block 628.

At block 628, the prospect ranking model trainer labels the input vectors of the prospects with a ranking value based on the FFV and risk classification. The labelling can be based on a manual interpretation of the seismic data and risk-related data. The rank can comprise a position within a set of prospects in rank order or a ranking value. In some embodiments, input vectors for each prospect can be labeled as they are created or iteratively. In other embodiments, input vectors for the prospects of the training data are ranked and labeled as a set.

At block 630, the prospect ranking model trainer obtains feature values for the currently selected prospect of the training data based at least on FFV, risk classification, and play type.

Features for ranking will most likely be consistent across fields, therefore features will most likely be predefined. Examples of feature values include FFV, risk classification, and play type. In some embodiments, a ranking feature set can also include other variables such as depth in the reservoir, fracking requirements, pore pressure, etc. The prospect ranking model trainer reads and/or derives values for the features that have been selected for the model from the data of the selected prospect.

At block 632, the prospect ranking model trainer generates input vectors for the currently selected prospect of the training data based on the feature values. The input vectors can contain null or empty values for one or more feature value of a prospect and the input vectors can be of variable length. Obtained feature values and input vector length can vary based on prospect size and available features.

At block 634, the prospect ranking model trainer determines if there is an additional prospect in the training set. If there is another prospect in the training set, flow continues to block 603 where another prospect is selected. Otherwise, flow continues to block 638.

At block 638, the prospect ranking model trainer labels the input vectors of the prospects with a ranking value based on the FFV, risk classification, and play type. The labelling can be based on a manual interpretation of the seismic data and risk-related data. The rank can comprise a position within a set of prospects in rank order or a ranking value for each prospect. In some embodiments, input vectors for each prospect can be labeled as they are created or iteratively. In other embodiments, input vectors for the prospects of the training data are ranked and labeled as a set.

At block 642, the prospect ranking model trainer trains a machine learning model with the input vectors corresponding to the prospects of the training set. Internal model parameters are adjusted based on the evaluation of ranking against labels. Embodiments can feed the input vectors in at different times (e.g., as each is generated, as a batch of all prospects of the training data, etc.).

For this example, it is assumed the training termination criterion is implied by the prospect training set as previously described in reference to the risk classification model training data. A given amount of resources (e.g., 20 person hours) is expended to curate the training set and training is complete once the trainer has iterated through the training set. However, a termination training criterion can be applied based on model performance, such as a generalization error criterion. If the performance-based criterion is not satisfied, embodiments can generate a notification or indication that an additional set of one or more prospects be added to the training set.

At block 670, the prospect ranking model trainer deploys the machine learning model to rank prospects of the field not selected in the training set. Optionally, the prospect ranking model trainer can deploy a model to rank substantially all prospects of the field including those prospects included in the training data for which prospect rankings have been previously generated.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 604 and 606 can be performed in parallel or concurrently. With respect to FIG. 2, historical exploration success per play type is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

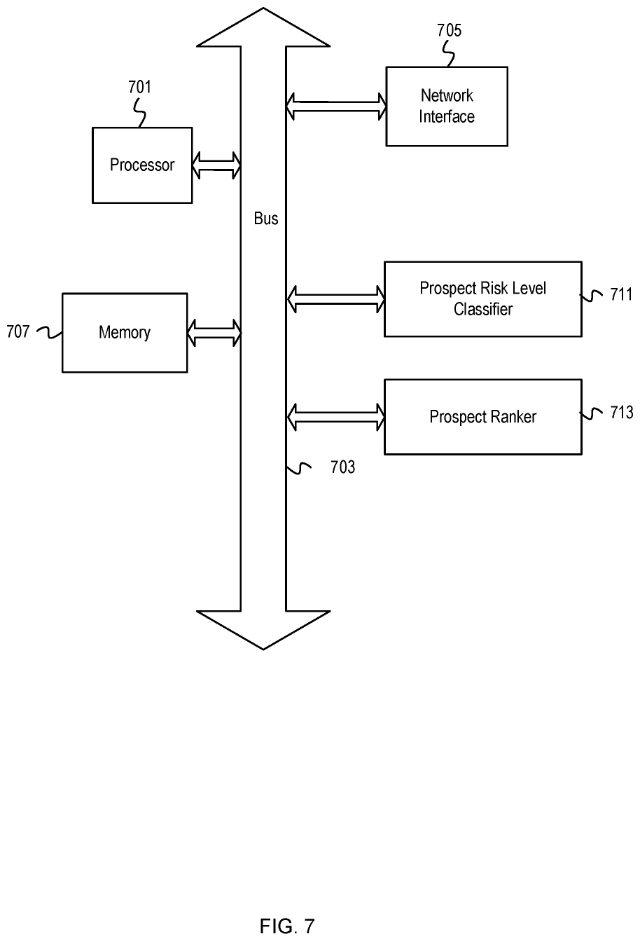

FIG. 7 depicts an example computer system with a prospect risk level classifier and a prospect ranker. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system communicates via transmissions to and/or from remote devices via the network interface 705 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.). The system also includes prospect risk level classifier 711 and prospect ranker 713. The prospect risk level classifier 711 is a trained model to classify risk for a prospect or region of a prospect. The prospect ranker 713 is a trained model to rank prospects based on economic value. The prospect risk level classifier 711 and the prospect ranker 713 can be a single model or an ensemble of models. The prospect risk level classifier 711 can output risk level classifications to the prospect ranker 713 or to memory 707 or other storage. The prospect ranker 713 is at least in communication with the output of the prospect risk level classifier 711. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for ranking prospect of a field as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Embodiment 1: A method comprising: generating risk classifications for a first plurality of prospects with a first trained machine learning model, wherein the first trained machine learning model has been trained to classify a prospect based, at least partly, on reservoir surveying data; determining measures of reservoir volume for a second plurality of prospects; training a second machine learning model to rank prospects based, at least partly, on the measures of reservoir volume and the risk classifications of a first subset of the second plurality of prospects that have been ranked; and generating rankings of a second subset of the second plurality of prospects with the trained second machine learning model based, at least in part, on inputting into the trained second machine learning model the measures of reservoir volume and risk classifications of the second subset of the second plurality of prospects.

Embodiment 2: The method of embodiment 1 wherein determining measures of reservoir volume comprises determining a frequency filtered volume for each of the second plurality of prospects.

Embodiment 3: The method of embodiment 2, wherein determining a frequency filtered volume for each of the second plurality of prospects comprises: for each region of the prospect, determining a measured reservoir thickness based, at least partly, on a gross rock volume corresponding to the region, wherein the gross rock volume is determined based, at least partly, on a dominant seismic frequency of a seismic survey of the prospect; determining a seismic resolution limit based, at least partly, on a seismic frequency at a location of the region of the prospect; based on a determination that the measured reservoir thickness is smaller than the seismic resolution limit, multiplying the gross rock volume of the region of the prospect by a resolution scalar factor to produce a frequency filtered volume of the region of the prospect; based on a determination that the measured reservoir thickness is not smaller than the seismic resolution limit, setting the gross rock volume as the frequency filtered volume of the region of the prospect; and summing the frequency filtered volume of each region of the prospect to obtain the frequency filtered volume of the prospect.

Embodiment 4: The method of any one of embodiments 1 to 3, wherein training the second machine learning model further comprises training the second machine learning model to rank prospects based, at least partly, on play type.

Embodiment 5: The method of embodiment 4, wherein the first subset of the second plurality of prospects have been ranked based, at least partly, on historical success data corresponding to the play type.

Embodiment 6: The method of embodiment 5, further comprising: updating at least one rank of the first subset of the second plurality of prospects that have been ranked based, at least partly, on additional historical success data corresponding to the play type; and retraining the second machine learning model to rank prospects based, at least partly, on the measures of reservoir volume and the risk classifications of the first subset of the second plurality of prospects that have been updated in at least one rank.

Embodiment 7: The method of any one of embodiments 1 to 6, wherein the reservoir surveying data comprises seismic surveying data.

Embodiment 8: The method of any one of embodiments 1 to 7, wherein the reservoir surveying data comprises at least one of petroleum element scores, direct hydrocarbon indictors, and critical risk segment maps of a third plurality of prospects.

Embodiment 9: The method of embodiment 8, wherein there is at least some overlap between the first plurality of prospects, the second plurality of prospects, and the third plurality of prospects.

Embodiment 10: A non-transitory machine-readable media having instruction stored thereon that are executable by a computing device, the instruction comprising instruction to: generate risk classifications for a first plurality of prospects with a first trained machine learning model, wherein the first trained machine learning model has been trained to classify a prospect based, at least partly, on reservoir surveying data; determine measures of reservoir volume for a second plurality of prospects; train a second machine learning model to rank prospects based, at least partly, on the measures of reservoir volume and the risk classifications of a first subset of the second plurality of prospects that have been ranked; and generate rankings of a second subset of the second plurality of prospects with the trained second machine learning model based, at least in part, on inputting into the trained second machine learning model the measures of reservoir volume and risk classifications of the second subset of the second plurality of prospects.

Embodiment 11: The machine-readable media of embodiment 10, wherein instructions to determine measures of reservoir volume for a second plurality of prospects comprise instructions to determine a frequency filtered volume for each of the second plurality of prospects.

Embodiment 12: The machine-readable media of embodiment 11, wherein instructions to determine a frequency filtered volume for each of the second plurality of prospects comprise instructions to: for each region of the prospect, determine a measured reservoir thickness based, at least partly, on a dominant seismic frequency of a seismic survey of the prospect and a gross rock volume of the region of the prospect; determine a seismic resolution limit based, at least partly, on a seismic frequency at a location of the region of the prospect; based on a determination that the measured reservoir thickness is smaller than the seismic resolution limit, multiply the gross rock volume of the region of the prospect by a resolution scalar factor to produce a frequency filtered volume of the region of the prospect; based on a determination that the measured reservoir thickness is not smaller than the seismic resolution limit, set the gross rock volume as the frequency filtered volume of the region of the prospect; and sum the frequency filtered volume of each region of the prospect to obtain the frequency filtered volume of the prospect.

Embodiment 13: The machine-readable media of any one of embodiments 10 to 12, wherein instructions to train the second machine learning model to rank prospects further comprise instruction to: train the second machine learning model to rank prospects based, at least partly, on play type, wherein the first subset of the second plurality of prospects have been ranked based, at least partly, on historical success data corresponding to the play type.

Embodiment 14: The machine-readable media of embodiment 13, further comprising instruction to: update at least one rank of the first subset of the second plurality of prospects that have been ranked based, at least partly, on additional historical success data corresponding to the play type; and retrain the second machine learning model to rank prospects based, at least partly, on the measures of reservoir volume and the risk classifications of the first subset of the second plurality of prospects that have been updated in at least one rank.

Embodiment 15: The machine-readable media of any one of embodiments 10 to 14, wherein the reservoir surveying data comprises at least one of petroleum element scores, direct hydrocarbon indictors, and critical risk segment maps of a third plurality of prospects.

Embodiment 16: An apparatus comprising: a processor; and a machine-readable medium having instructions stored thereon that are executable by the processor to cause the apparatus to, generate risk classifications for a first plurality of prospects with a first trained machine learning model, wherein the first trained machine learning model has been trained to classify a prospect based, at least partly, on reservoir surveying data; determine measures of reservoir volume for a second plurality of prospects; train a second machine learning model to rank prospects based, at least partly, on the measures of reservoir volume and the risk classifications of a first subset of the second plurality of prospects that have been ranked; and generate rankings of a second subset of the second plurality of prospects with the trained second machine learning model based, at least in part, on inputting into the trained second machine learning model the measures of reservoir volume and risk classifications of the second subset of the second plurality of prospects.

Embodiment 17: The apparatus of embodiment 16, wherein instructions to determine measures of reservoir volume for a second plurality of prospects comprise instructions to determine a frequency filtered volume for each of the second plurality of prospects.

Embodiment 18: The apparatus of embodiment 17, wherein instructions to determine a frequency filtered volume for each of the second plurality of prospects comprise instructions to: for each region of the prospect, determine a measured reservoir thickness based, at least partly, on a dominant seismic frequency of a seismic survey of the prospect and a gross rock volume of the region of the prospect; determine a seismic resolution limit based, at least partly, on a seismic frequency at a location of the region of the prospect; based on a determination that the measured reservoir thickness is smaller than the seismic resolution limit, multiply the gross rock volume of the region of the prospect by a resolution scalar factor to produce a frequency filtered volume of the region of the prospect; based on a determination that the measured reservoir thickness is not smaller than the seismic resolution limit, set the gross rock volume as the frequency filtered volume of the region of the prospect; and sum the frequency filtered volume of each region of the prospect to obtain the frequency filtered volume of the prospect.

Embodiment 19: The apparatus of any one of embodiments 16 to 18, wherein instructions to train the second machine learning model to rank prospects further comprise instruction to: train the second machine learning model to rank prospects based, at least partly, on play type, wherein the first subset of the second plurality of prospects have been ranked based, at least partly, on historical success data corresponding to the play type.

Embodiment 20: The apparatus of embodiment 19, further comprising instruction to: update at least one rank of the first subset of the second plurality of prospects that have been ranked based, at least partly, on additional historical success data corresponding to the play type; and retrain the second machine learning model to rank prospects based, at least partly, on the measures of reservoir volume and the risk classifications of the first subset of the second plurality of prospects that have been updated in at least one rank.

Embodiment 21: The apparatus of any one of embodiments 16 to 20, wherein the reservoir surveying data comprises at least one of petroleum element scores, direct hydrocarbon indictors, and critical risk segment maps of a third plurality of prospects.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
generating risk classifications for a first plurality of prospects with a first trained machine learning model, wherein the first trained machine learning model has been trained to classify a prospect based, at least partly, on reservoir surveying data;
determining measures of reservoir volume for a second plurality of prospects;
training a second machine learning model to rank prospects based, at least partly, on the measures of reservoir volume and the risk classifications of a first subset of the second plurality of prospects that have been ranked; and
generating rankings of a second subset of the second plurality of prospects with the trained second machine learning model based, at least in part, on inputting into the trained second machine learning model the measures of reservoir volume and risk classifications of the second subset of the second plurality of prospects.

2. The method of claim 1 wherein determining measures of reservoir volume comprises determining a frequency filtered volume for each of the second plurality of prospects.

3. The method of claim 2, wherein determining a frequency filtered volume for each of the second plurality of prospects comprises:
for each region of the prospect,
determining a measured reservoir thickness based, at least partly, on a gross rock volume corresponding to the region, wherein the gross rock volume is determined based, at least partly, on a dominant seismic frequency of a seismic survey of the prospect;
determining a seismic resolution limit based, at least partly, on a seismic frequency at a location of the region of the prospect;
based on a determination that the measured reservoir thickness is smaller than the seismic resolution limit, multiplying the gross rock volume of the region of the prospect by a resolution scalar factor to produce a frequency filtered volume of the region of the prospect;
based on a determination that the measured reservoir thickness is not smaller than the seismic resolution limit, setting the gross rock volume as the frequency filtered volume of the region of the prospect; and
summing the frequency filtered volume of each region of the prospect to obtain the frequency filtered volume of the prospect.

4. The method of claim 1, wherein training the second machine learning model further comprises training the second machine learning model to rank prospects based, at least partly, on play type.

5. The method of claim 4, wherein the first subset of the second plurality of prospects have been ranked based, at least partly, on historical success data corresponding to the play type.

6. The method of claim 5, further comprising:
updating at least one rank of the first subset of the second plurality of prospects that have been ranked based, at least partly, on additional historical success data corresponding to the play type; and
retraining the second machine learning model to rank prospects based, at least partly, on the measures of reservoir volume and the risk classifications of the first subset of the second plurality of prospects that have been updated in at least one rank.

7. The method of claim 1, wherein the reservoir surveying data comprises seismic surveying data.

8. The method of claim 1, wherein the reservoir surveying data comprises at least one of petroleum element scores, direct hydrocarbon indictors, and critical risk segment maps of a third plurality of prospects.

9. The method of claim 8, wherein there is at least some overlap between the first plurality of prospects, the second plurality of prospects, and the third plurality of prospects.

10. A non-transitory machine-readable media having instruction stored thereon that are executable by a computing device, the instruction comprising instruction to:
generate risk classifications for a first plurality of prospects with a first trained machine learning model, wherein the first trained machine learning model has been trained to classify a prospect based, at least partly, on reservoir surveying data;
determine measures of reservoir volume for a second plurality of prospects;
train a second machine learning model to rank prospects based, at least partly, on the measures of reservoir volume and the risk classifications of a first subset of the second plurality of prospects that have been ranked; and
generate rankings of a second subset of the second plurality of prospects with the trained second machine learning model based, at least in part, on inputting into the trained second machine learning model the measures of reservoir volume and risk classifications of the second subset of the second plurality of prospects.

11. The machine-readable media of claim 10, wherein instructions to determine measures of reservoir volume for a second plurality of prospects comprise instructions to determine a frequency filtered volume for each of the second plurality of prospects.

12. The machine-readable media of claim 11, wherein instructions to determine a frequency filtered volume for each of the second plurality of prospects comprise instructions to:
for each region of the prospect,
determine a measured reservoir thickness based, at least partly, on a dominant seismic frequency of a seismic survey of the prospect and a gross rock volume of the region of the prospect;
determine a seismic resolution limit based, at least partly, on a seismic frequency at a location of the region of the prospect;
based on a determination that the measured reservoir thickness is smaller than the seismic resolution limit, multiply the gross rock volume of the region of the prospect by a resolution scalar factor to produce a frequency filtered volume of the region of the prospect;
based on a determination that the measured reservoir thickness is not smaller than the seismic resolution limit, set the gross rock volume as the frequency filtered volume of the region of the prospect; and
sum the frequency filtered volume of each region of the prospect to obtain the frequency filtered volume of the prospect.

13. The machine-readable media of claim 10, wherein instructions to train the second machine learning model to rank prospects further comprise instruction to:
train the second machine learning model to rank prospects based, at least partly, on play type, wherein the first subset of the second plurality of prospects have been ranked based, at least partly, on historical success data corresponding to the play type.

14. The machine-readable media of claim 13, further comprising instruction to:
update at least one rank of the first subset of the second plurality of prospects that have been ranked based, at least partly, on additional historical success data corresponding to the play type; and
retrain the second machine learning model to rank prospects based, at least partly, on the measures of reservoir volume and the risk classifications of the first subset of the second plurality of prospects that have been updated in at least one rank.

15. The machine-readable media of claim 10, wherein the reservoir surveying data comprises at least one of petroleum element scores, direct hydrocarbon indictors, and critical risk segment maps of a third plurality of prospects.

16. An apparatus comprising:
a processor; and
a machine-readable medium having instructions stored thereon that are executable by the processor to cause the apparatus to,
generate risk classifications for a first plurality of prospects with a first trained machine learning model, wherein the first trained machine learning model has been trained to classify a prospect based, at least partly, on reservoir surveying data;
determine measures of reservoir volume for a second plurality of prospects;
train a second machine learning model to rank prospects based, at least partly, on the measures of reservoir volume and the risk classifications of a first subset of the second plurality of prospects that have been ranked; and
generate rankings of a second subset of the second plurality of prospects with the trained second machine learning model based, at least in part, on inputting into the trained second machine learning model the measures of reservoir volume and risk classifications of the second subset of the second plurality of prospects.

17. The apparatus of claim 16, wherein instructions to determine measures of reservoir volume for a second plurality of prospects comprise instructions to determine a frequency filtered volume for each of the second plurality of prospects.

18. The apparatus of claim 17, wherein instructions to determine a frequency filtered volume for each of the second plurality of prospects comprise instructions to:
for each region of the prospect,
determine a measured reservoir thickness based, at least partly, on a dominant seismic frequency of a seismic survey of the prospect and a gross rock volume of the region of the prospect;
determine a seismic resolution limit based, at least partly, on a seismic frequency at a location of the region of the prospect;
based on a determination that the measured reservoir thickness is smaller than the seismic resolution limit, multiply the gross rock volume of the region of the prospect by a resolution scalar factor to produce a frequency filtered volume of the region of the prospect;
based on a determination that the measured reservoir thickness is not smaller than the seismic resolution limit, set the gross rock volume as the frequency filtered volume of the region of the prospect; and
sum the frequency filtered volume of each region of the prospect to obtain the frequency filtered volume of the prospect.

19. The apparatus of claim 16, wherein instructions to train the second machine learning model to rank prospects further comprise instruction to:
train the second machine learning model to rank prospects based, at least partly, on play type, wherein the first subset of the second plurality of prospects have been ranked based, at least partly, on historical success data corresponding to the play type.

20. The apparatus of claim 19, further comprising instruction to:
update at least one rank of the first subset of the second plurality of prospects that have been ranked based, at least partly, on additional historical success data corresponding to the play type; and
retrain the second machine learning model to rank prospects based, at least partly, on the measures of reservoir volume and the risk classifications of the first subset of the second plurality of prospects that have been updated in at least one rank.

21. The apparatus of claim 16, wherein the reservoir surveying data comprises at least one of petroleum element scores, direct hydrocarbon indictors, and critical risk segment maps of a third plurality of prospects.
